(19) United States
(12) Patent Application Publication
(10) Pub. No.: US 2001/0032444 A1
(43) Pub. Date: Oct. 25, 2001

(54) Bridle bit animal medication dispenser

(76) Inventor: Lawrence Michael Baugher, Athens, AL (US)

Correspondence Address: Joseph H. Beumer, 555 SPARKMAN, SUITE 1602, Huntsville, AL, 35816, US

(21) Appl. No.: 09/793,835

(22) Filed: Feb. 26, 2001

Related U.S. Application Data
(60) Provisional application No. 60/185,976, filed on Mar. 1, 2000.

(51) Int. Cl. B68B 1/06; A01K 29/00; A61J 7/00

(52) U.S. Cl. 54/7; 119/833; 604/79

(57) ABSTRACT

A dispenser for administering liquid or paste medication to a horse has a hollow tube open at one end for insertion of a plunger rod and is closed off at an intermediate location by a stop, with an upward-pointing aperture for ejection located adjacent the stop. The tube is supported at each end by members attachable to a bridle, with the tube and support members simulating normal components of a bridle. For liquid medication the liquid is introduced into the tube through the ejection aperture, with the plunger rod in place. For paste material the medication is introduced axially into the open end of the tube by a tight-fitting syringe, and the same syringe is then used to eject a portion of the medicine. Ejection is then completed by removing the syringe and inserting the plunger rod to eject the remaining material.

### CROSS REFERENCE TO RELATED APPLICATION

This application claims the benefit of applicant's provisional application Ser. No. 60/185,976, filed Mar. 1, 2000.

### FIELD OF THE INVENTION

This invention relates to instruments for administering medicine to large animals such as horses.

### BACKGROUND OF THE INVENTION

A need frequently arises for improved devices for administering medication to horses. If the dispenser presents an appearance and “feel” substantially different from equipment such as bridles and bits familiar to the horse, difficulty will likely arise in obtaining the horse's cooperation. Strange-looking devices, combined with unfamiliar smells and tastes of the medicine, may result in forcible resistance by the horse and expulsion of the medicine before it can be swallowed. Devices making use of some similarity to a bridle bit have been developed over the years, such devices typically having a hollow tube open at one end and a plunger operating in the tube to force the medicine through an aperture into the horse's mouth.

Prior devices are exemplified by U.S. Pat. No. 5,557,905, issued Sep. 24, 1996, to Harding and Pat. No. 4,040,422, issued Aug. 7, 1977, to Kuhn. The Harding patent discloses a dispenser bit having a hollow tube and a plunger operable to force paste-like medicine out of a hole in the bottom side of the tube when held in a horizontal position. This type of device is useful only for paste material which would not flow out of the tube by gravity before being placed in position for being injected into the horse's mouth. The patent to Kuhn also discloses a tubular dispenser, the tube being open at one end outside the horse's mouth and closed at an inner location adjacent to an aperture through which the medication is forced by means of a plunger. Liquid medication is fed by gravity into the tube from a container extending radially upward from a location near the outside end. This arrangement is useful only for liquid medication which flows readily into the tube. A cartridge with its own plunger is also suggested and partially disclosed for paste material, the cartridge being inserted into the tube. This design would appear to require custom-built cartridges and a re-design of portions of the dispenser.

It is desired to provide a dispensing device useful to enable, without modification, both liquid and paste medication to be effectively injected into a horse's mouth. The dispenser should be adapted to closely simulate the usual look and feel of a bit and bridle, with hardware such as upwardly extending containers being avoided to the maximum extent. In addition, the dispenser should have ends of the tubular bit member securely connected to end supports for effective grasping, or the bit should be connectable to bridles of the type which provide for bit removal and replacement.

### SUMMARY OF THE INVENTION

The present invention is directed to an animal medication dispenser comprising a hollow tube simulating a horse bridle bit, the tube having a first end and a second end, the first end being closed and the second end open to allow introduction of flowable medication and receiving a plunger operable to force the medication toward the second end. A stop is provided at a location spaced-apart from the second end, and an aperture through the tube wall is located inward of the stop at the top side of the tube when disposed horizontally.

The first end may be connected to a supporting member of a type used on conventional bridles such as a side shank connectible to the bridle by straps or to a bit-retaining receptacle of a bridle which provides a capability for replacement of bits. The second end of the tube may extend outward past the usual end of a bit for a distance such as one and one-half to two inches to support the plunger in alignment for insertion into the tube.

In operation of the dispenser, medication may be introduced into the hollow, container portion of the tube by means of a suitable syringe at a location, which varies with liquid or paste-like medications. For liquid medications, a syringe with a tip which fits into the tube ejection aperture may be used to fill up the tube to a desired level. To prevent loss of liquid, the tube may be held with the aperture extending upward until the tube is installed for use. In the case of paste-like medicine, this material is introduced by being moved axially through the open end with the plunger rod removed. In a preferred two-step procedure, a syringe having a large tip and collar which fits snugly around the base of the tip and within the tube end is used to introduce the paste and also to eject a portion by forcing it out through the aperture by action of the syringe plunger. The balance of the paste is then removed by insertion of the plunger rod and pushing it to reach the stop in the tube. Medication dispensed by this procedure is unlikely to be wasted or ejected by the horse. Changes from conventional bit structure and connecting bridle hardware are minimized.

### BRIEF DESCRIPTION OF THE DRAWINGS

FIG. 1 is a sectional view taken along lines 1, 4; 1, 4 of FIG. 3 and along the length of a bit-like medication dispenser tube installed on a pair of shanks and aligned to receive a plunger;

FIG. 2 is a pictorial view of a dispenser tube connected to bit-supporting members of a bridle having bit-replacement capability;

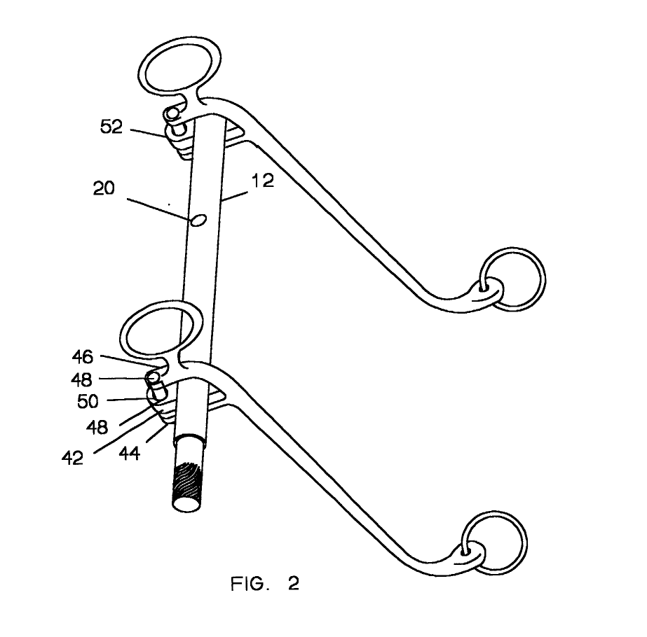

FIG. 3 is a dispenser as shown in FIG. 1 with a syringe in dashed lines aligned for insertion of liquid medication;

FIG. 4 is a view of the dispenser tube of FIG. 1 with a syringe aligned axially for insertion of paste-like medication.

### DESCRIPTION OF THE PREFERRED EMBODIMENT

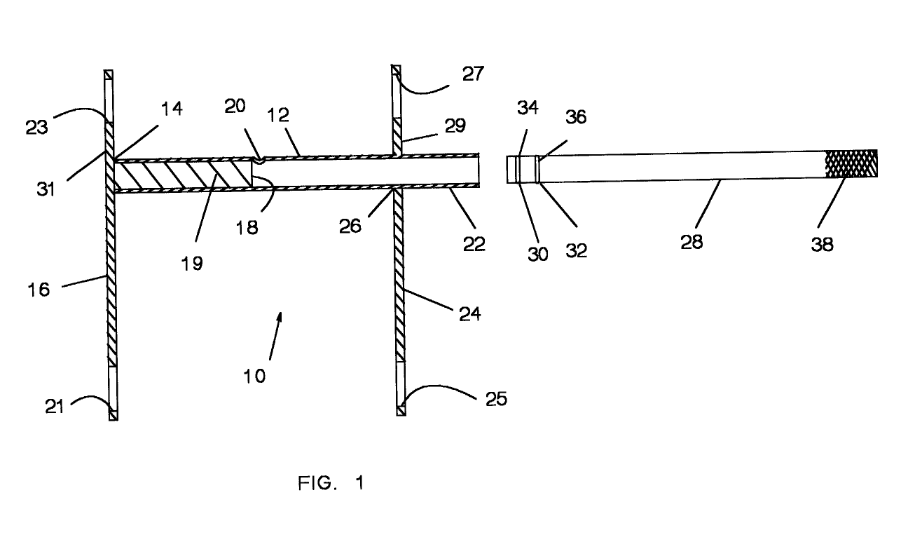

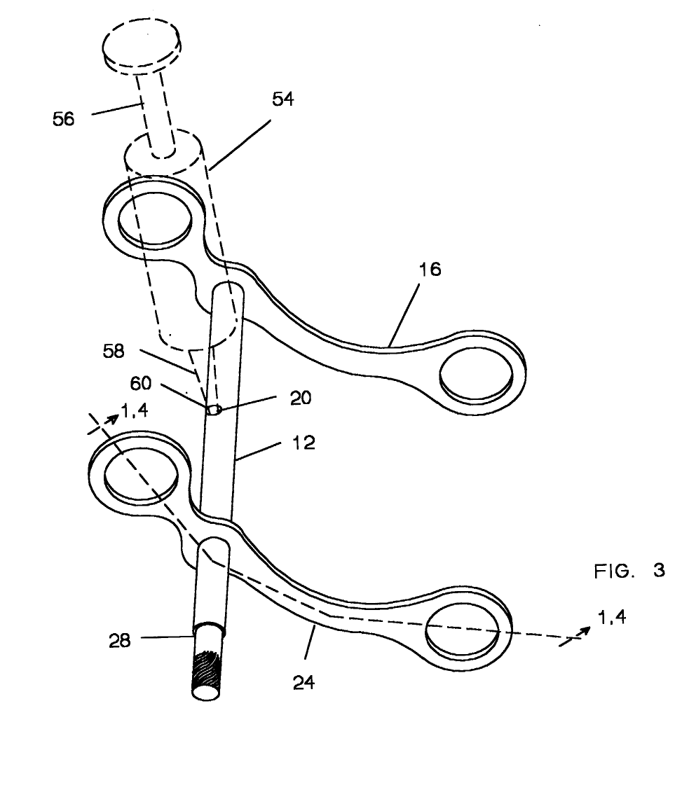

Referring to FIG. 1 of the drawings, there is shown a dispenser 10 using a hollow tube 12 adapted for placement in a horse's mouth in a manner similar to conventional bits, to which the horse would be accustomed. The tube has a first end 14 to which is attached by welding a first side shank member 16. Spaced inward axially from the first end a stop 18 is placed to extend across the tube, so that the medicine will be ejected out through an aperture 20 adjacent the stop on the inside thereof. The aperture extends through the tube wall in vertically upward direction when the tube is placed in its normal horizontal alignment in the horse's mouth. As shown in FIGS. 1 and 3, the dispenser tube 12 is mounted on a pair of side shank members 16, 24 each of which has a diagnoally extending base portion 29, 31 and an enlarged ring 21, 23 and 25, 27 at each end. This structure for a bridle bit is used in some horse bridles and is designed to be connected to other parts of the bridle by means of straps threaded through the rings. Aperture 20 is located at a point on the circumference of the tube which is at the top thereof when the shank members supporting the tube are rotated to their normal position when the bridle is in use on the horse.

The plunger 28 is arranged for insertion into the dispenser tube in a manner such that leaking of liquid medication out of the outer end of the tube is prevented. For this purpose O-rings 30, 32 are disposed in circumferential grooves 34, 36 near the inner end of the plunger. A gnarled knob 38 is provided at its outer end to facilitate grasping. A lubricant such as petroleum jelly may be applied to the O-rings for easier operation. This measure also serves to prevent loss of liquid medication out of the aperture by gravity in the event that the tube is inadvertently held with the aperture away from a topmost position.

The preferred method of administering medication in accordance with this invention varies with the nature of the medication, in particular whether it is in the form of a free-flowing liquid or a paste or paste-like material which requires action of a plunger to fill the tube as well as to eject it out. Filling the tube with a liquid is shown in FIG. 3. A measured amount of liquid is fed from a syringe 54 into aperture 20 by action of plunger 56 of the syringe. For this operation a small diameter end 60 of tip 58 or a suitable needle extends well into the tube, with the inserted tip or needle fitting into the aperture loosely to provide effective filling.

For medications in the form of paste, the medication may be advantageously introduced axially through the open end of the tube rather than through the aperture which extends through the tube wall. In a preferred procedure, the tube is filled with paste from the syringe and a major portion such as one-half of the medication is ejected into the horse's mouth in a single step by action of the syringe plunger. The syringe has an adapter collar which allows the base of the tip of the syringe to be snapped into a tight-fitting position. This enables more force to be exerted against the plunger of the syringe without causing some of the paste to be moved backward out of the open end of the tube. After this step the remaining one-half portion of the paste may be ejected from the tube by withdrawing the syringe, inserting the plunger rod and moving it forward in the manner described for liquid medication.

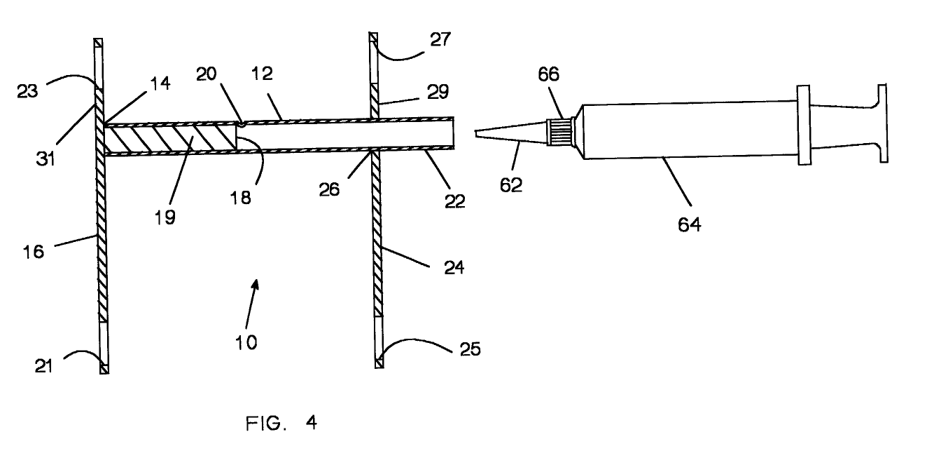

As shown in FIG. 4 the dispensing tip 62 of syringe 64 has a collar 66 at the base thereof. Syringes of type shown come equipped with a cap which closes off the tip end and is slidable into position with its proximate end engaging the base of the tip. A short portion adjacent the proximate end of such cap may be cut off and secured against the base portion of the tip with an adhesive. Certain two ounce syringes of the type shown in FIG. 4 come equipped with a cap that fits exactly into a one-half inch inner diameter tube. Caps for such syringes having a varying diameter along their length and a collar of a selected diameter may be obtained to fit a specific tube.

The dispensing tube and plunger rod for the device of this invention may be made of stainless steel, with the dispensing tube preferably having an inner diameter of one-half inch. The stop provided in the tube may take the form of an end of a solid rod inserted tightly and sealing off the tube. A diameter of one-eighth inch may be used for the aperture which extends through the tube wall. Lengths of the tube between supporting members may be varied depending on the type of horse and the bridle involved. Typically this portion of the tube would be made to correspond to bit sizes ranging from three and one-half to six and one-half inches. The portion of the tube which extends past the support member and provides for initial placement of the plunger rod may have a length of one and one-half to two inches.

In regard to the syringe used for insertion of paste medication into the end of the tube a two-ounce syringe available for Becton Dickinson Company may be used for this purpose. Syringes of this size have an advantage in that a base part of an end cap for these devices fits snugly into the one-half inch tube and provides the basis for an effective and convenient procedure for inserting and ejecting the medication.

Prior to injecting the medication into the dispenser tube, it is preferred to mix it with a substance such as applesauce which masks the taste of medicine to some extent and which is palatable to horses. In addition to medication in the form of a liquid or paste, this invention may be used for tablets, which would be ground into powdered form and mixed with applesauce to form a paste of a suitable consistancy. If necessary, flour or other thickening agents may be used to provide a paste with a higher viscosity.

While the invention is described above in terms of specific embodiments, it is not to be understood as so limited, but is limited only by the appended claims.

1. A device for dispensing flowable, medication-containing material into a horse's mouth comprising:
a. partially hollow tubular member having a first end and a second end, said first end being closed and said second end being open and adapted to receive a plunger inserted axially therein, a stop member extending across said tube at an intermediate position, an aperture penetrating a wall of said tube and allowing said material to be ejected therethrough;
a pair of tube support members one of each connected to an end of said tube;
said tube having a top side and a bottom side when located horizontally in a horse's mouth;
said aperture extending through said top side of said tube;
means for inserting said material into said tube; and
plunger means operable in an axial direction inward from said second end to forcibly eject said material into said horse's mouth.

2. The device as defined in claim 1 wherein said second end of said tube extends outward sufficiently far to allow said plunger to be inserted and held in alinment at a location outside of said horse's mouth.

3. The device as defined in claim 2 wherein said means for inserting said material comprises a syringe.

4. The device as defined in claim 3 wherein said medication material is a liquid and said syringe is adapted for inserting said liquid into said tube through said aperture.

5. The device as defined in claim 4 wherein said syringe comprises a tip sized to fit loosely in said aperture.

6. The device as defined in claim 5 wherein said plunger means comprises a cylindrical rod having located adjacent the insertable end thereof a plurality of O-rings placed in circumferential grooves defined in said rod.

7. The device as defined in claim 1 wherein said material comprises a paste and said syringe is adapted for insertion into said second end.

8. The device as defined in claim 7 wherein said syringe includes a tip having an outer end and a base and said base is adapted to fit tightly within said second end of said tube.

9. The device of claim 8 further comprising a collar connected to said tip and encircling a base region thereof, said collar having an outside diameter sized to be tightly engaged against said tube.

10. The method of dispensing a medication-containing paste material into a horse's mouth comprising:
providing a hollow metal tube having a first, open end, a second end and a stop closing off said tube at a central location, an aperture, defined in a wall of said tube at a location adjacent to the stop between the stop and the open end, a plunger rod slidably disposed in said tube for axial movement therein and a syringe arranged to have a tip end thereof fit tightly within said tube at said open end;
inserting into said syringe a selected amount of said material;
removing said plunger rod;
placing said syringe so that the tip thereof extends axially into said open end of the tube and a base portion of said tip comes into tight contact with an interior location of said open end;
advancing a plunger within said syringe so as to inject said material into said tube;
further advancing said plunger of said syringe whereby a major portion of said material is ejected through said aperture;
removing said syringe from said tube;
placing said plunger rod into said open tube end; and
advancing said plunger rod toward said stop where an additional amount of said material is ejected.
